(19) United States
(12) Patent Application Publication
(10) Pub. No.: US 2017/0116385 A1
(43) Pub. Date: Apr. 27, 2017

(54) Clinical Message Autocomplete and Electronic Medical Record System Integration

(71) Applicant: Voalte, Inc., Sarasota, FL (US)

(72) Inventors: Trey Lauderdale, Sarasota, FL (US); Candace S. Smith, Parrish, FL (US); Philip N. Fibiger, Winter Park, FL (US)

(73) Assignee: Voalte, Inc., Sarasota, FL (US)

(21) Appl. No.: 14/919,767

(22) Filed: Oct. 22, 2015

(51) Int. Cl. G06F 19/00; G06F 3/0484; G06F 3/0482; G06F 17/24

(52) U.S. Cl. CPC G06F 19/3425; G06F 17/243; G06F 3/04842; G06F 3/0482

(57) ABSTRACT

Systems and methods can support autocompletion of textual messages entered by a clinical user into a clinical messaging system. Clinical information comprising one or more record elements associated with a data field may be retrieved from an electronic medical records system. Textual input may be received from a clinical user. An indication of the data field may be detected within the textual input. A list of field completion suggestions may be populated from the one or more record elements associated with the data field. The list may be presented to the clinical user. A selection of one of the suggestions may be received from the clinical user. Text associated with the received selection may be inserted into the data field within the textual input. The textual input and related metadata may be stored into the electronic medical records system and a logical linkage may be established thereto.

### BACKGROUND

Clinical care providers working within a healthcare enterprise, such as a hospital, need to effectively and efficiently communicate with one another in a rapid, or real-time, fashion. Textual messages entered on computers and mobile devices are increasingly a preferred method for such communications. Entering detailed specifics into these messages, such as patient names, test results, or pharmacological dosages, may be time consuming or error prone, especially since clinicians are often under a great deal of stress, rushed, and are already multitasking.

Furthermore, freeform entry of such details each time they are used does not support associating the details with similar information stored within other electronic information systems. Thus, various disjoint collections of communicated information are being created outside of existing efforts to aggregate and organize all patient related information within clinical information systems such as electronic medical record systems.

There is a need in the art for healthcare clinical communication systems operable to autocomplete or autopopulate specific information fields using data already present in other information systems related to medical records, communications, staff workflow, and so forth. There is a further need for such autocompletion of data to support logical linking (and updating) to the same, similar, or related data in other information systems toward the important goal of integrating and coordinating healthcare information to improve efficiency and efficacy of care delivery.

### SUMMARY

In certain example embodiments described herein, methods and systems can support autocompletion of textual messages entered by a clinical user into a clinical messaging system. Data communications may be established between the clinical messaging system and an electronic medical records system. Clinical information (comprising one or more record elements associated with a data field) may be retrieved from the electronic medical records system. Textual input may be received from a clinical user. An indication of the data field may be detected within the textual input. A list of field completion suggestions may be populated from the one or more record elements associated with the data field. The list may be presented to the clinical user. A selection of one of the suggestions may be received from the clinical user. Text associated with the received selection may be inserted into the data field within the textual input. The textual input and related metadata may be stored into the electronic medical records system and a logical linkage may be established thereto.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an integration management system within a healthcare enterprise in accordance with one or more embodiments presented herein.

FIG. 2 is a user interface diagram depicting a clinical messaging autocomplete scenario in accordance with one or more embodiments presented herein.

FIG. 3 is a block flow diagram depicting a method for clinical messaging autocomplete and electronic medical record integration in accordance with one or more embodiments presented herein.

FIG. 4 is a block diagram depicting a computing machine and a module in accordance with one or more embodiments presented herein.

### DETAILED DESCRIPTION OF EXAMPLE EMBODIMENTS

### Overview

The technology presented herein can support autocompletion of textual input (such as a message) from a clinical user. The textual input may be autocompleted using information from a clinical information system such as an electronic medical record system. While the text is being entered, a field indicator symbol (such as an asterisk, hash sign, or various others) may indicate the beginning of a data field for autocompletion. Such a data field may comprise patient name, patient condition, physician name, procedure, so forth. Using data from the clinical information system, a list of field completion suggestions may be populated to autocomplete the indicated data field.

The items, or records, populated within the field completion suggestions may be selected for presentation to the user in a context-aware fashion or may be otherwise attached to a workflow associated with the clinical user. Context clues may also influence which of the field completion suggestions is given initial selection focus or is placed preferentially within the list for suggested preference to the clinical user. Such context clues may be established, or modified, by modeling behavior or prior actions of the clinical user or a population of users.

The user can select one of the field completion suggestions to insert text associated with selection into the textual input being generated by the user. Accordingly, autocomplete functionality may be achieved using intelligence suggested by a clinical information system such as an electronic medical record system. Logical linkages may be maintained between inserted text and the clinical information system. The text inserted by the autocomplete functionality may remain cross-referenced (or linked) to related data. Such links may be used to reference, or relate to, information associated with the data field. Furthermore, the textual input may be stored into the clinical information system according to the logical linkages. For example, when autocomplete of a patient name or identifier links a message or other communication to particular patient, the message and/or related information may be annotated back into the chart or electronic medical records associated with that patient. The information may also be relayed to other displays associated with the patient, such as a chart, patient dashboard, patient portal, wall display, or status timeline.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

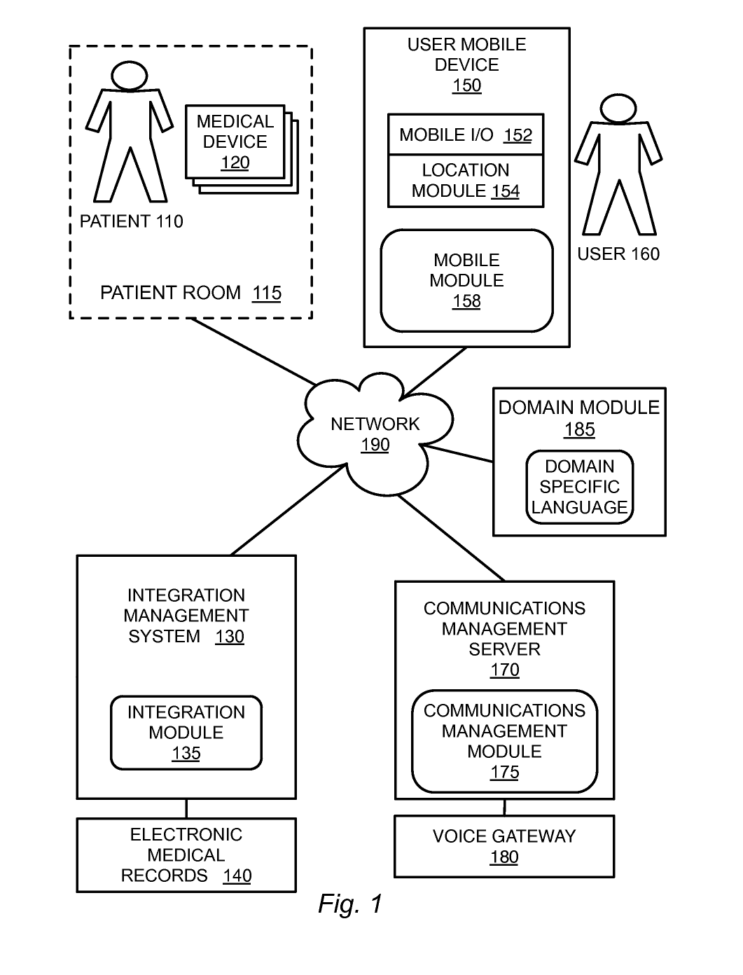

FIG. 1 is a block diagram depicting an integration management system 130 within a healthcare enterprise in accordance with one or more embodiments presented herein. The integration management system 130 can execute one or more integration modules 135 to integrate information and communication events within the healthcare enterprise. Such integration may include retrieving information from, and pushing information to, one or more systems supporting electronic medical records 140. A user 160 can employ a user mobile device 150 to send and receive messages, alerts, notifications, and engage in other modalities of communication. The user mobile device 150 can leverage various mobile input/output (I/O) 152 modalities such as touch screens, microphones, speakers, video displays, and so forth. The user mobile device 150 can also incorporate one or more location modules 154 for determining location and motion. The information being processed by the integration management system 130 may be associated with one or more patients 110 or other operations associated with the healthcare enterprise. For example, alerts or alarms may originate from medical devices 120 in a patient room 115 or otherwise associated with the patient 110 for communication to the user 160 and/or the electronic medical records 140. A communication management server 170 may execute one or more communication management modules 175 to coordinate communication between the patient 110, the integration management system 130, and the user 160. This communication may include voice or video calls coupled through a voice gateway 180. A domain module 185 may support the use of domain specific languages in associated with the integration management system 130. The patient 110, associated medical devices 120, integration management system 130, user 160, associated user mobile device 150, communication management server 170, and other various system elements may be in data communications through one or more networks 190.

The integration management system 130, in conjunction with associated integration module 135, may support clinical message autocomplete functionality presented herein. The integration module 135 may also support decision support, data analysis, modeling, prediction, or other related functions. It should be appreciated that while the functionality presented herein is generally described in relation to the integration management system 130, any such functionality may be implemented within the integration management system 130, the user mobile device 150, other systems within the healthcare enterprises, or in any combination thereof. Collectively, and in general, these may be referred to as a clinical messaging system.

The functionality presented herein may be supported by the integration management system 130 obtaining processing information associated with the patient 110 and information associated with various clinical operations. Such information within the healthcare enterprise may be communicated between the electronic medical records 140 and the integration management system 130. These communications may leverage various technologies including, for example, Wireless Communications Transfer Protocol (WCTP), Wi-Fi, XML, HTTP, TCP/IP, or various other networking protocols, technologies, or topologies. These communications may follow one or more messaging standards that define how information is packaged and communicated from one system to another. Such standards can specify languages, structures, and/or data types for integrating information between systems. An example of such a standard is Health Level Seven (HL7), which includes a set of rules for information to be shared and processed in a uniform and consistent manner within the healthcare enterprise.

The electronic medical records system 140 may also be referred to as electronic health records or electronic patient records. Such electronic medical records 140 may be generated and maintained within a healthcare enterprise such as a hospital, integrated delivery network, clinic, or physician office. Electronic medical records 140 can provide patients, physicians, other health care providers, employers, payers, or insurers access to patient medical records. Such access may be provided across multiple facilities. Electronic medical records 140 may be a systematic collection of electronic health information about an individual patient or population. Electronic medical records 140 may include a variety of information such as demographics, medical history, medications, allergies, immunization status, laboratory test results, radiology images, vital signs, personal statistics, age, weight, billing, and insurance information. The electronic medical records system 140 may be implemented to represent data that accurately captures the state of the patient at substantially all times. Patient histories may be viewed from the electronic medical records system 140. Storing the patient information in a single digital system can assist in ensuring data is accurate, appropriate and legible. It can reduce the chances of data replication by providing a singular file that is constantly up to date and obviates any issues with lost forms or paperwork. Electronic medical records system 140 can simplify the extraction of medical data for the examination of possible trends. Thus elucidating long-term changes in one particular patient and also simplifying research across populations.

The patient room 115 may include communications or monitor devices. These may include a camera, video display, microphone, speaker, or various other sensors. The microphone and speaker can support voice communications or intercom functionality. Addition of a camera and/or video display can support video monitoring or even video conferencing. For example, a user 160 can communicate with, listen to, or visually observe the patient 110 from a user mobile device 150 or other computing machine or communication device. For example, the patient may be visually monitored from a computer display at a nurse station. The various communication modalities may be supported by the communication management server 170 and may interface through the voice gateway 180 to existing voice communication systems (such as VoIP, PBX, or POTS systems) or similar video conferencing systems.

The user 160 may be a care provider in a hospital or other care facility. The user 160 may be a nurse, physician, therapist, technician, assistant, specialist, or any other care provider. The user 160 can interface with a user mobile device 150 for making and receiving messages, notifications, or communications. The mobile modules 158 can provide software, firmware, or hardware for executing the functionality of the user mobile device 150 as discussed herein. The mobile I/O 152 can include various sensors, input, and output mechanisms associated with the user mobile device 150. These may include touch screens, microphones, speakers, video displays, and so forth. The location module 154 can provide the user mobile device 150 with location awareness for use within the user mobile device 150 or relaying to the integration management system 130. The location modules 154 can include GPS, beacon locating, wireless access point positioning, RTLS, or other mapping/location services. Wireless access point positioning can determine the location of the user mobile device 150 based upon which wireless access points it is currently able to connect with and possibly what their respective apparent power levels read as.

It should be appreciated that the user 160 may also interface through a desktop computer or workstation instead of a user mobile device 150. For example, the user 160 may be using a desktop computer system in the office or at a nurse's station in a hospital or other care facility.

The domain module 185 may support one or more domain specific languages. A domain specific language may be specified for use within a particular knowledge domain. Examples of knowledge domains in a healthcare context may include pharmacy, nursing, radiology, cardiology, and so forth. Domain specific language information associated with the domain module 185 may support autocomplete and integration technologies presented herein. Domain specific language information can provide prediction, completion options, and other functions. For example, when it is detected that a message related to medication is being entered, domain specific knowledge may provide a list of likely medicines as well as typical dosages. According to other examples, integration with electronic medical records 140 may provide information to flag known allergies or to detect potential drug interactions. According to other example, domain knowledge may predict that a message is directed to, or referencing, the on-call cardiologist when terminology such as “angiogram” or “stress test” are included or recently used.

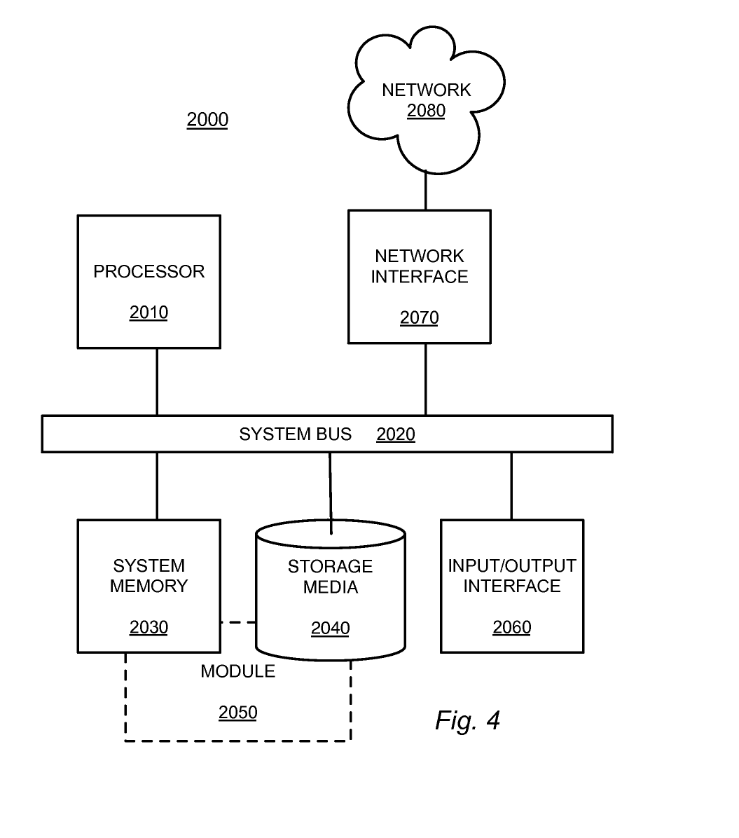

The integration management system 130, user mobile device 150, communication management server 170, electronic medical records system 140, domain module 185, systems associated with the patient room 115, other systems associated with the users 160, or any other systems associated with the technology presented herein may be any type of computing machine such as, but not limited to, those discussed in more detail with respect to FIG. 4. Furthermore, any modules (such as the integration module 135, mobile modules 158, or communication management modules 175) associated with any of these computing machines or any other modules (scripts, web content, software, firmware, or hardware) associated with the technology presented herein may by any of the modules discussed in more detail with respect to FIG. 4. The computing machines discussed herein may communicate with one another as well as other computer machines or communication systems over one or more networks such as network 190. The network 190 may include any type of data or communications network including any of the network technology discussed with respect to FIG. 4.

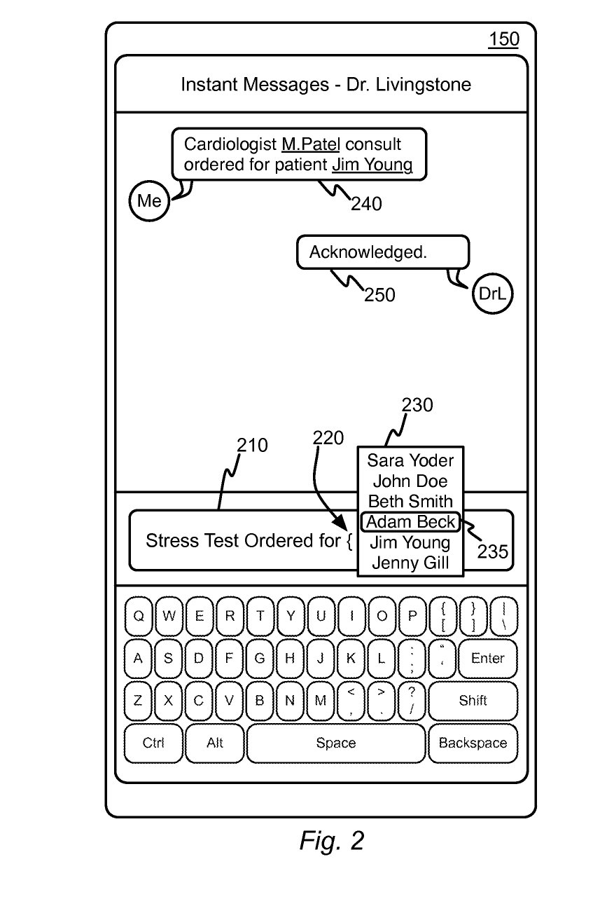

FIG. 2 is a user interface diagram depicting a clinical messaging autocomplete scenario in accordance with one or more embodiments presented herein. A user mobile device 150 can display a user interface featuring clinical messaging autocomplete technology. The user 160 can enter a message in a message entry box 210. The message may be targeted for transmission to another user 160, such as “Dr. Livingstone” in the illustrated example. While entering the message, the user may user a field indicator symbol 220 to indicate that a particular field is to be inserted into the message. In the illustrated example, the field indicator symbol 220 is an open brace also known as an open curly bracket. In the illustrated example, the entered field indicator symbol 220 has been specified to indicate the field of patient names. Entering the field indicator symbol 220 causes a list of field completion suggestions 230 to appear for the user 160 to select from. In the illustrated example, the field completion suggestions 230 are a list of patient names. The user 160 can select one of the field completion suggestions 230 in various ways. These may include touching/clicking one of the suggestions, typing the initial letters of their desired entry, scrolling a suggestion selector 235 over the desired selection, and so forth. While scrolling or browsing the field completion suggestions 230, the suggestion selector 235 may be said to indicate the current focus of the listed suggestions. Generally, proceeding (for example hitting space or enter) will select the focus item from the items listed among the field completion suggestions 230.

The illustrated messaging interface also shows examples of a previous transmitted message 240 and a previous received message 250 listed in a conversation format. The previous transmitted message 240 is shown as originating from the user 160, who is designated as “Me.” The previous received message 250 is shown as originating from “Dr. Livingstone” who is designated as “DrL.” Portions of the previous messages that were autocompleted fields may remain cross-referenced (also referred to as being linked) to related data. For example, the individuals “M.Patel” and “Jim Young” are displayed within the previous transmitted message 240 as links. Such links may be used to pull up information related to those individuals. When the linking cross-reference is to a clinician, it may be used to pull up, or relate to, contacts, location, schedule, roles, responsibilities, expertise, other cases, other patients, and so forth. When the linking cross-reference is to a patient it may be used to pull up their chart, records, or other useful information.

The field indicator symbol 220 may be any symbol. Several examples, among others, include ampersand, apostrophe, asterisk, at sign, single quote, single back quote, double quote, slash, back slash, open brace, close brace, open bracket, close bracket, open parenthesis, close parenthesis, carat, colon, comma, dollar, equal, exclamation mark, greater than, less than, hyphen, percent, pipe, plus, hash, semi-colon, tilde, underscore, and so forth. A different field indicator symbol 220 may be assigned to different common fields. For example, the at sign may be used to indicate that a patient name is to follow, while and a carrot may be used to indicate a specialist and percentage to indicate a procedure name. These field indicator symbol 220 meanings may be preset, default, or may be configured by, or for, groups or individual users 160.

According to certain embodiments, the inclusion of a field may be initiated predictively instead of, or in addition to, using the field indicator symbol 220. For example, the user 160 enters the text “blood work ordered for” it can easily be predicted that the next entry may be a patient name. Accordingly, a list of field completion suggestions 230 showing patient name may be presented for selection. It should be appreciated that the entry may be using voice to text technology. In a voice entry scenario, the predictive field insertion may be particularly useful. Furthermore, voice field indicators may be used in a similar fashion as the field indicator symbol 220. For example, speaking “blood work ordered for patient” may initiate section from a suggested list of patient names. In the voice entry scenario, the selection may be made by matching the next spoken sounds to the list of possible patients.

Various information fields may benefit from the clinical messaging autocomplete technology presented herein. For example, these fields may include patient names, room numbers, clinician names, specialist domains, conditions, requests for labs, procedures, medications, follow-ups, approval, acknowledgements, referrals, responses, and so forth. The sources of the autocompleted information or field completion suggestions 230 may include electronic medical records 140, domain specific modules, clinician information (such as roles, responsibilities, schedules, locations, specialties, etc.), usage models, and various other databases or information systems within the healthcare enterprise.

Items populated within the field completion suggestions 230 may be context aware or may be otherwise attached to a workflow associated with the user 160. For example, the location, pending alarm/alert, recent alarm/alert, last message received/sent, roles/responsibilities, recent voice/video call, or other information may influence the field completion suggestions 230 offered for autocomplete. According to certain examples, the field completion suggestions 230 for patient name offered to a clinician entering a message may include the patients assigned to that clinician on the current shift. Furthermore, if the location module 154 has determined that the clinician is, or was just recently, located in the room of a particular assigned patient, that patient may be determined to my most likely or most relevant. As such, that patient name may be populated at the top of the list within the field completion suggestions 230. Similarly, that patient name may be given initial focus within the list or may be the initial position of the suggestion selector 235. According to yet another example, a nurse who has just received an alert or alarm associated with a medical device 120 associated with a particular patient may start to send a message to another clinician. While entering the message, the name of the patient from the alarm may be placed at the top of the list within the field completion suggestions 230, may be given initial focus within the list, or may be the initial position of the suggestion selector 235.

The technology presented herein may model and learn communication styles of the user 160. For example, if a user 160 frequently sends a patient related message shortly after exiting that patient's room, then information about patient John Doe may be used for auto complete, suggestions, or initial focus when a message is entered shortly after exiting John Doe's room.

When autocomplete of a patient name or identifier links a message or other communication to particular patient, the message and/or relate information may be annotated back into the chart or electronic medical records 140 associated with that patient. This may occur when a linking cross-reference relates to a particular patient in some way. Automatically saving communications linked to a patient back to their chart or electronic medical records 140 can create traceability of the communications. For example, it may be stored that physician was notified of a condition, outcome, or status, that the physician received the information, and whether or not the physician acknowledged the communication or responded in some other way. Accordingly, confirmation and nonrepudiation may be maintained within the electronic medical records 140. The information may also be relayed to other displays associated with the patient, such as a chart, patient dashboard, patient portal, wall display, or status timeline. Videos, images, lab results, or other digital information communicated by the user 160 may also be stored to the electronic medical records 140 or other data systems in the same, or similar, fashion. In addition to the clinical message autocomplete technology supporting messages and other communications between clinical care providers, the communications may be between a clinician and the patient, a clinician and an information gateway (such as a patient portal), or the communication may be made directly to a chart or electronic medical records 140 in the form of a clinical notes or memo to the patient's file.

The messages or communication techniques presented herein may be leveraged for communicating clinical orders (for example, from a physician to a nurse or therapist). Such communications may also be automatically updated to records associated with the patient within the electronic medical records 140 or various other displays, databases, or information systems.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

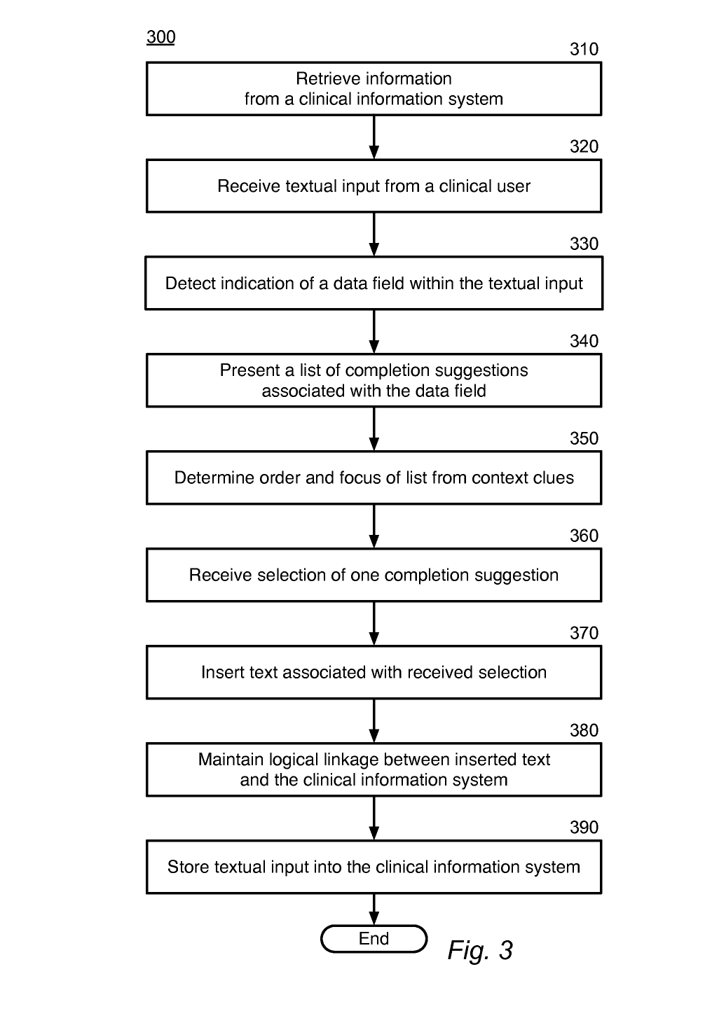

FIG. 3 is a block flow diagram depicting a method for clinical messaging autocomplete and electronic medical record integration in accordance with one or more embodiments presented herein. It should be appreciated that these operations may take place within the integration management system 130, the user mobile device, some other system, or some combination thereof. In block 310, the integration management system 130 can retrieve information from a clinical information system such as the electronic medical record system 140. The clinical information system may include various other sources of clinical information such as domain specific modules, clinician information (such as roles, responsibilities, schedules, locations, specialties, etc.), usage models, and various other databases or information systems within the healthcare enterprise. The retrieved clinical information may comprise one or more record elements associated with a data field. Among various other examples, the data field may comprise patient name, patient condition, patient location, clinician, procedure, result, pharmaceutical, therapy, and so forth.

In block 320, the integration management system 130 can receive textual input from a clinical user 160. The textual input may be associated with a mobile clinical message, a notification, alert, any other communication, or notation/memo.

In block 330, the integration management system 130 can detect indication of a data field within the textual input. The introduction of the data within the textual input may be indicated by a field indicator symbol 220. The field indicator symbol 220 may be a hash sign, an at sign, a bracket, or various other symbol as presented herein. A particular field indicator symbol 220 may be assigned to a particular field such as patient name, condition, or other fields as discussed herein. Indication of a data field within the textual input may also be detected by prediction, modeling, context, voice cue, or any other input cue. Among various others, some examples of such input cues may include shaking a mobile device, clicking, pausing, and so forth.

In block 340, the integration management system 130 can present a list of completion suggestions associated with the data field. These suggestions may include the information retrieved from the clinical information system with respect to block 310. For example, is a field indicator symbol 220 associated with patient names is entered, a list of field completion suggestions 230 showing possible patient names may appear for the user 160 to select from.

In block 350, the integration management system 130 can determine an ordering and/or initial selection focus for the list of field completion suggestions 230 from context clues.

The items populated within the field completion suggestions 230 may be selected in a context aware fashion or may be otherwise attached to a workflow associated with the user 160. For example, the location, pending alarm/alert, recent alarm/alert, last message received/sent, roles/responsibilities, recent voice/video call, or other information may influence the field completion suggestions 230 offered for autocomplete. Context clues may also influence which of the field completion suggestions 230 is given initial selection focus, is placed preferentially within the list, has suggestion selector 235 focus, or is otherwise suggested for preference by the user 160. It should be appreciated that, according to certain embodiments, such context clues may be established, or modified, by modeling of behavior or prior actions of the user 160 or a population of users 160.

In block 360, the integration management system 130 can receive selection of one completion suggestion from the user 160. The user 160 can select one of the field completion suggestions 230 in various ways. These may include touching/clicking one of the suggestions, typing the initial letters of their desired entry, scrolling a suggestion selector 235 over the desired selection, and so forth.

In block 370, the integration management system 130 can insert text associated with selection into the text being entered by the user 160. Accordingly, autocomplete functionality may be achieved using intelligence suggested by the clinical information system such as an electronic medical record system 140.

In block 380, the integration management system 130 can maintain logical linkage between inserted text and the clinical information system. The text inserted by the autocomplete functionality may remain cross-referenced (or linked) to related data. Such links may be used to reference, or relate to, information associated with the data field.

In block 390, the integration management system 130 can store the textual input into the clinical information system according to the logical linkages. For example, when autocomplete of a patient name or identifier links a message or other communication to particular patient, the message and/or related information may be annotated back into the chart or electronic medical records 140 associated with that patient. Storing communications linked to a patient back to their chart or electronic medical records 140 can create traceability of the communications. Related metadata may also be stored into the clinical information system. Such related metadata may include any of a sender identifier, a recipient identifier, an indicator of receipt by the recipient, a time stamp, a sender location, a recipient location, references to related communication, and so forth.

The stored information may also be relayed to other displays associated with the patient, such as a chart, patient dashboard, patient portal, wall display, or status timeline. Videos, images, lab results, or other digital information communicated by the user 160 may also be stored to the electronic medical records 140 or other data systems in the same, or similar, fashion.

### Example Systems

FIG. 4 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for coordinating a clinical messaging system with a clinical information system, comprising:
establishing data communications between the clinical messaging system and the clinical information system;
retrieving, by the clinical messaging system, clinical information from the clinical information system, wherein the clinical information comprises one or more record elements associated with a data field;
receiving, by the clinical messaging system, textual input from a clinical user;
detecting, by the clinical messaging system, an indication of the data field within the textual input;
populating, by the clinical messaging system, a list of field completion suggestions from the one or more record elements associated with the data field;
presenting, by the clinical messaging system, the list of field completion suggestions to the clinical user;
receiving, by the clinical messaging system, selection of one of the field completion suggestions from the clinical user;
inserting, by the clinical messaging system, text associated with the received selection into the data field within the textual input;
maintaining, by the clinical messaging system, a logical linkage between the inserted text and the clinical information system; and
storing, by the clinical messaging system, the textual input and related metadata into the clinical information system.

2. The computer-implemented method of claim 1, wherein the textual input is a message entered into a mobile computing device.

3. The computer-implemented method of claim 1, wherein the indication of the data field comprises a text symbol.

4. The computer-implemented method of claim 1, wherein detecting the indication of the data field comprises textual prediction.

5. The computer-implemented method of claim 1, wherein the data field comprises one of a patient identifier, a clinician identifier, a clinical procedure, a patient condition, a pharmaceutical treatment, and a clinical test result.

6. The computer-implemented method of claim 1, wherein populating the list of field completion suggestions comprises filtering the one or more record elements according to a context clue comprising one of a location of the clinical user, a recent communication associated with the clinical user, and a usage pattern associated with the clinical user.

7. The computer-implemented method of claim 1, wherein presenting the list of field completion suggestions to the clinical user comprises sorting the list according to a context clue comprising one of a location of the clinical user, a recent communication associated with the clinical user, and a usage pattern associated with the clinical user.

8. The computer-implemented method of claim 1, wherein presenting the list of field completion suggestions to the clinical user comprises placing an initial selection focus within the list according to a context clue comprising one of a location of the clinical user, a recent communication associated with the clinical user, and a usage pattern associated with the clinical user.

9. The computer-implemented method of claim 1, further comprising updating the stored textual input to one of a patient chart, a patient dashboard, and a patient information portal.

10. The computer-implemented method of claim 1, wherein the related metadata comprises one or more of a sender identifier, a recipient identifier, an indicator of receipt by the recipient, a time stamp, a sender location, a recipient location, and a reference to a related communication.

11. A clinical messaging system, comprising:
one or more processing units, and one or more processing modules, wherein the clinical messaging system is configured by the one or more processing modules to:
establish data communications to a clinical information system;
retrieve clinical information from the clinical information system, wherein the clinical information comprises one or more record elements associated with a data field;
receive textual input from a clinical user;
detect an indication of the data field within the textual input;
populate a list of field completion suggestions from the one or more record elements associated with the data field;
present the list of field completion suggestions to the clinical user;
receive a selection of one of the field completion suggestions from the clinical user;
insert text associated with the received selection into the data field within the textual input;
maintain a logical linkage between the inserted text and the clinical information system; and
store the textual input and related metadata into the clinical information system.

12. The medical alarm management system of claim 11, wherein the textual input is a communication message entered into a mobile computing device.

13. The medical alarm management system of claim 11, wherein the indication of the data field comprises a text symbol.

14. The medical alarm management system of claim 11, wherein detecting the indication of the data field comprises textual prediction.

15. The medical alarm management system of claim 11, wherein the data field comprises one of a patient identifier, a clinician identifier, a clinical procedure, a patient condition, a pharmaceutical treatment, and a clinical test result.

16. The medical alarm management system of claim 11, wherein populating the list of field completion suggestions comprises filtering the one or more record elements according to a context clue comprising one of a location of the clinical user, a recent communication associated with the clinical user, and a usage pattern associated with the clinical user.

17. The medical alarm management system of claim 11, wherein presenting the list of field completion suggestions to the clinical user comprises sorting the list, or initializing selection within the list, according to a context clue comprising one of a location of the clinical user, a recent communication associated with the clinical user, and a usage pattern associated with the clinical user

18. The medical alarm management system of claim 11, wherein the clinical messaging system is further configured to update the stored textual input to one of a patient chart, a patient dashboard, and a patient information portal.

19. The medical alarm management system of claim 11, wherein the related metadata comprises one or more of a sender identifier, a recipient identifier, an indicator of receipt by the recipient, a time stamp, a sender location, a recipient location, and a reference to a related communication.

20. A computer program product, comprising:
a non-transitory computer-readable storage medium having computer-readable program code embodied therein that, when executed by one or more computing devices, perform a method comprising:
establishing data communications between a clinical messaging system and an electronic medical records system;
retrieving clinical information from the electronic medical records system, wherein the clinical information comprises one or more record elements associated with a data field;
receiving textual input associated with a message from a clinical user;
detecting, within the textual input, an indication of the data field;
populating a list of field completion suggestions from the one or more record elements associated with the data field;
presenting the list of field completion suggestions to the clinical user;
receiving a selection of one of the field completion suggestions from the clinical user;
inserting text associated with the received selection into the data field position within the textual input;
storing the textual input and related metadata into the electronic medical records system; and
updating the textual input to one of a patient chart, a patient dashboard, and a patient information portal.
